(19) United States
(12) Patent Application Publication
(10) Pub. No.: US 2014/0215225 A1
(43) Pub. Date: Jul. 31, 2014

(54) METHOD FOR INCREASING THE SECURITY OF SOFTWARE

(71) Applicant: Samsung Electronics Co., Ltd., Suwon-si (KR)

(72) Inventor: Oleksandr KOLIESNIK, Kiev (UA)

(73) Assignee: Samsung Electronics Co., Ltd., Suwon-si (KR)

(21) Appl. No.: 14/143,551

(22) Filed: Dec. 30, 2013

(30) Foreign Application Priority Data
Jan. 30, 2013 (KR) 10-2013-0010701

(51) Int. Cl. G06F 21/14

(52) U.S. Cl. CPC G06F 21/14
USPC 713/190; 726/26; 713/189

(57) ABSTRACT

A method for increasing security of software is provided. The method includes replacing a part of a code section comprised in a binary source file of the software with a pre-set special command, creating a table of correspondence that contains correspondence information between the part of the code section and the pre-set special command according to the replacing, and inserting the table of correspondence into a command preprocessor execution file of the software.

### CROSS-REFERENCE TO RELATED PATENT APPLICATION

This application claims priority from Korean Patent Application No. 10-2013-0010701, filed on Jan. 30, 2013, in the Korean Intellectual Property Office, the disclosure of which is incorporated herein in its entirety by reference.

### BACKGROUND

1. Field

Methods and apparatuses consistent with exemplary embodiments may relate to a method of protecting a binary source file in order to increase the security of software, and a non-transitory computer-readable recording medium having recorded thereon the method.

2. Description of the Related Art

With recent development of personal computers (PCs) and various smart devices, the value of software as well as hardware is increasing. However, software has no shape and is prone to duplication, and thus in many cases, software is used without authorization or reversely-engineered by hackers for illegal purposes.

Such unauthorized use of software may be prevented by a protection technique for preventing source code outflow. Examples of a recently-used software protection techniques include a technique of assigning a specific key to a source file, a method of preventing access to a source code via software encryption (decryption), and the like. However, these methods have the possibility of being disassembled down to source code, and thus are not safe from reverse-engineering hacking techniques. Moreover, some of these methods provide low performance due to their use of software encryption and decryption methods.

### SUMMARY

One or more exemplary embodiments provide protecting a source file by preventing unauthorized accesses to the source file and/or reverse-engineering of the source file by replacing conditional and unconditional jumps of the source file and by creating a preprocessor execution file in which replacement correspondence is encrypted.

One or more exemplary embodiments also provide preventing the application of a high load on a central processing unit (CPU) by performing encryption and/or decryption using a hardware protection module to perform encryption and/or decryption to protect software.

According to an aspect of an exemplary embodiment, there is provided a method for increasing the security of software, the method including replacing a part of a code section included in a binary source file of the software with a pre-set special command; creating a table of correspondence that contains correspondence information between the part of the code section and the pre-set special command according to the replacing; and inserting the table of correspondence into a command preprocessor execution file of the software.

The replaced part of the code section may be at least one of a conditional jump and an unconditional jump.

The table of correspondence may include at least one of the pre-set special commands, the conditional jump, and the unconditional jump, a conditional jump location, and an unconditional jump location.

The method may further include encrypting the table of correspondence.

The encrypting of the created table of correspondence may be provided by a hardware device.

The pre-set special command may represent a location of the replaced part of the code section.

The pre-set special command may be included in the table of correspondence.

The method may further include creating a hardware security key, and encrypting the special command by using the hardware security key.

At least one hardware security key may be created to encrypt each of a plurality of pre-set special commands.

All of a plurality of pre-set special commands may be encrypted using a single hardware security key.

The hardware security key may be created using at least one of a Hardware Against Software Piracy (HASP) method, a Hardlock method, and an etoken method.

The method may further include performing postprocessing that allows a user to use a modified file. A modified binary source file and a modified command preprocessor execution file may be stored in response to the postprocessing being completed.

The method may further include encrypting another code section of the modified command preprocessor execution file in which the table of correspondence exists.

The encrypting of the code section of the modified command preprocessor execution file may be provided by a hardware device.

The method may further include archiving the modified binary source file, and producing a descriptor of the archived modified binary source file in a data section of the modified command preprocessor execution file.

According to an aspect of another exemplary embodiment, there is provided a non-transitory computer-readable recording medium having recorded thereon a computer program, which, when executed by a computer, performs the method for increasing the security of software.

### BRIEF DESCRIPTION OF THE DRAWINGS

The above and other aspects will become more apparent by describing in detail exemplary embodiments with reference to the attached drawings in which:

FIG. 1 is a block diagram schematically illustrating a method for increasing the safety of software, according to an exemplary embodiment;

FIG. 2 is a schematic diagram illustrating a method of encrypting a table of correspondence by using a security key, according to an exemplary embodiment

FIG. 3 is a flowchart of a method for increasing the safety of software, according to an exemplary embodiment;

FIG. 4 is a flowchart of an operation of generating a modified binary source file and a modified preprocessor execution file for software security according to an exemplary embodiment;

FIG. 5 is a flowchart of a sub-routine of an operation of modifying a binary source file, according to an exemplary embodiment;

FIG. 6 is a flowchart of a sub-routine of an operation of modifying a special command, according to an exemplary embodiment;

FIG. 7 is a flowchart of a sub-routine of an operation of modifying a preprocessor execution file, according to an exemplary embodiment;

FIG. 8 is a flowchart of a sub-routine of an operation of encrypting a specific part of a preprocessor execution file, according to an exemplary embodiment;

FIG. 9 is a flowchart of a sub-routine of an operation of archiving a source file, according to an exemplary embodiment; and

FIG. 10 is a flowchart of a sub-routine of an operation of creating a protected execution file, according to an exemplary embodiment.

### DETAILED DESCRIPTION OF EXEMPLARY EMBODIMENTS

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing steps and/or operations described is an example; however, the sequence of and/or operations is not limited to that set forth herein and may be changed as is known in the art, with the exception of steps and/or operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. The scope is defined not by the detailed description but by the appended claims. Like numerals denote like elements throughout.

The term “ . . . unit” used in the embodiments indicates a component including software or hardware, such as a Field Programmable Gate Array (FPGA) or an Application-Specific Integrated Circuit (ASIC), and the “ . . . unit” performs certain roles. However, the “ . . . unit” is not limited to software or hardware. The “ . . . unit” may be configured to be included in an addressable storage medium or to reproduce one or more processors. Therefore, for example, the “ . . . unit” includes components, such as software components, object-oriented software components, class components, and task components, processes, functions, attributes, procedures, subroutines, segments of program code, drivers, firmware, microcode, circuits, data, a database, data structures, tables, arrays, and variables. A function provided inside components and “ . . . units” may be combined into a smaller number of components and “ . . . units”, or further divided into additional components and “ . . . units”.

The term “module” as used herein means, but is not limited to, a software or hardware component, such as an FPGA or ASIC, which performs certain tasks. A module may advantageously be configured to reside on an addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

Although the terms used herein are generic terms which are currently widely used and are selected by taking into consideration functions thereof, the meanings of the terms may vary according to the intentions of persons skilled in the art, legal precedents, or the emergence of new technologies. Furthermore, some specific terms may be randomly selected by the applicant, in which case the meanings of the terms may be specifically defined in the description of the exemplary embodiment. Thus, the terms should be defined not by simple appellations thereof but based on the meanings thereof and the context of the description of the exemplary embodiment. As used herein, expressions such as “at least one of,” when preceding a list of elements, modify the entire list of elements and do not modify the individual elements of the list.

It will be understood that when the terms “includes,” “comprises,” “including,” and/or “comprising,” when used in this specification, specify the presence of stated elements and/or components, but do not preclude the presence or addition of one or more elements and/or components thereof. As used herein, the term “module” refers to a unit that can perform at least one function or operation and may be implemented utilizing any form of hardware, software, or a combination thereof. In the specification, when an element is referred to as being “connected” or “coupled” to another element, it may be directly connected or coupled to the other element or can be electrically and/or communicatively connected or coupled to the other element with intervening elements interposed there between.

As used herein, the term “and/or” includes any and all combinations of one or more of the associated listed items. Expressions such as “at least one of,” when preceding a list of elements, modify the entire list of elements and do not modify the individual elements of the list.

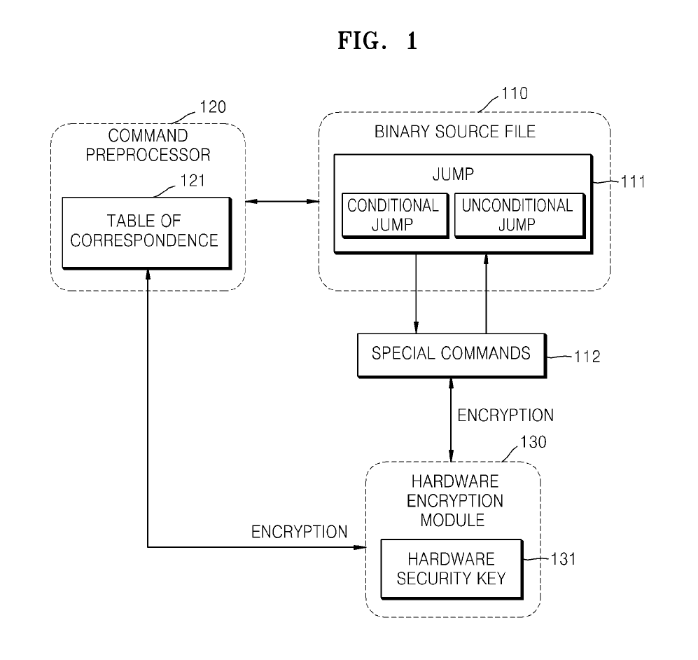

FIG. 1 is a block diagram schematically illustrating a method for increasing the safety of software, according to an exemplary embodiment.

Referring to FIG. 1, the method for increasing software security uses a binary source file 110 and a command preprocessor 120, which are included in the software. The method also uses a hardware encryption module 130, which generates a hardware security key 131 that performs encryption for protection of the binary source file 110.

The binary source file 110 includes jumps 111. Each jump 111 may include a conditional jump and an unconditional jump. The jumps 111 may be replaced by special commands 112 in order to prevent reverse-engineering or hacking of the binary source file 110.

The special commands 112 are a pool of commands pre-set to hide the jumps 111 included in the binary source file 110. For example, the special commands 112 may be key values corresponding to the locations of replaced jumps 111 or may be commands for replacing the conditional or unconditional jumps 111 of the binary source file 110. Of course, the special commands 112 are not limited thereto, and may be values arbitrarily set by a designer.

When the binary source file 110 is modified according to such replacement, a table of correspondence 121, which records values corresponding to replacements, is necessary for restoring the replaced jumps 111 later.

A key and a value that correspond to replaced jumps may be input to the table of correspondence 121. For example, the replaced jumps 111, the special commands 112, and the locations of the replaced jumps 111 may be input. Accordingly, the special commands 112 may be input as keys, and the replaced jumps 111 may be input as values. However, since the form of the table of correspondence 121 may be freely set by a user, it is not limited to the above examples.

A user may restore and process the binary source file 110 in which the jumps 111 have been replaced using the table of correspondence 121. The table of correspondence 121 may be created and then stored within the command preprocessor 120 as illustrated in FIG. 1, and may be populated during replacements of the jumps 111 with the special commands 112. Particularly, the table of correspondence 121 may be created in advance, and, every time a jump 111 found in the binary source file 110 is replaced by a special command 112, the correspondence may be added to the table of correspondence 121 to complete the table of correspondence 121. The completed table of correspondence 121 may be stored within the command preprocessor 120 as described later.

The command preprocessor 120 is a program or device that translates a processing sequence represented using a decision table into a COmmon Business-Oriented Language (COBOL) source program or, in other words, transforms a source program written using pseudo-instructions for structural programming into a command statement of an existing programming language. The table of correspondence 121 is a part of a decision table used to process the binary source file 110. Accordingly, during software execution, the command preprocessor 120 may be able to restore the binary source file 110 in which the jumps 111 have been replaced, by using the table of correspondence 121. The table of correspondence 121 may be recorded in a code section of a command preprocessor execution file (not shown) in order to exist within the command preprocessor 120. When the binary source file 110 and the table of correspondence 121 are encrypted using a security key, which will be described later, a security key table (not shown), which gives the authority to decrypt the encrypted binary source file 110 and the table of correspondence 121 as encrypted, may also be necessary.

Further, a hardware encryption module 130 generates a hardware security key 131 to encrypt the modified binary source file 110 and the command preprocessor 120. This is because, if the table of correspondence 121 is accessed , the binary source file 110 may be easily restored even if the binary source file 110 is modified. Thus, the encryption of both binary source file 110 and the table of correspondence 121 may be needed in order to prevent unauthorized accesses and reverse-engineering of the binary source file 110.

According to an exemplary embodiment, the hardware security key 131 is used to perform the encryption. The hardware security key 131 may be a pool of keys or a token, and is produced by the hardware encryption module 130. Methods such as Hardware Against Software Piracy (HASP), Hardlock, and eToken may be used to form the hardware security key 131. Of course, a method used to produce the hardware security key 131 is not limited thereto, and other methods may be used.

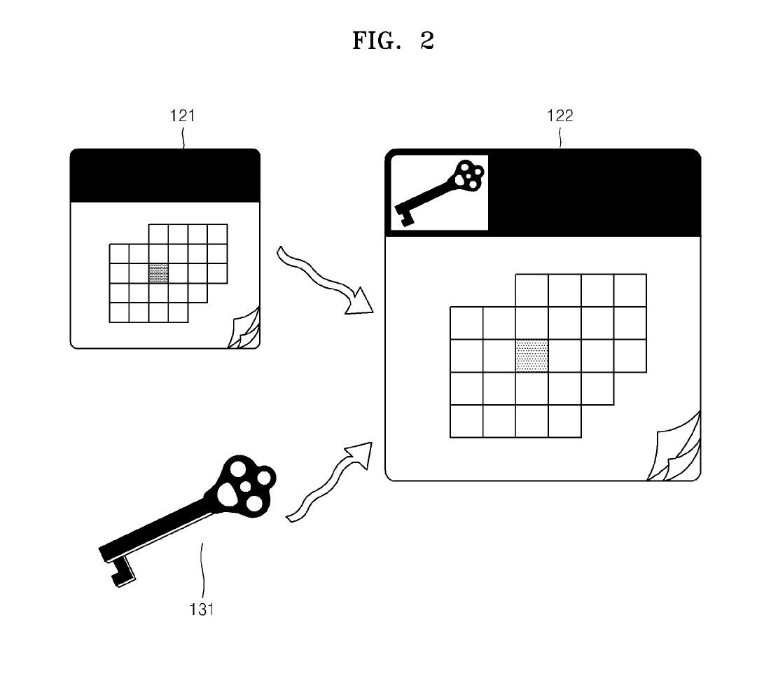

FIG. 2 is a schematic diagram illustrating a method of encrypting the table of correspondence 121 by using the hardware security key 131, according to an exemplary embodiment.

Referring to FIG. 2, the hardware security key 131 and the table of correspondence 121 are combined to produce an encrypted table of correspondence 122. Specifically, in order to prevent an unauthorized user of the hardware security key 131 from accessing the table of correspondence 121, the table of correspondence 121, or each value corresponding to jump replacements within the table of correspondence 121, are combined with the hardware security key 131 and are thus encrypted. According to an exemplary embodiment, as illustrated in FIG. 2, the entire table of correspondence 121 may be encrypted in its entirety by using only one hardware security key 131. According to another exemplary embodiment, values corresponding to replacements of the jumps 111 may be individually encrypted by using separate hardware security keys 131 produced for each of the replacements of the jumps 111. The former provides lower security compared with the latter, but also provides a low processing load for a central processing unit (CPU) because only one hardware security key 131 is used.

According to another exemplary embodiment, the hardware security key 131 is not only combined with the table of correspondence 121, but may also be combined with, or substituted by, the special commands 112 existing within the binary source file 110 in place of the jumps 111 in order to encrypt the special commands 112, of FIG. 1. Then, accesses to not only the table of correspondence 111 but also the special commands 112 of the binary source file 110 may be blocked without authorization of the hardware security key 131, and thus the possibility of reverse-engineering the binary source file 110 may be further prevented.

Consequently, only authorized users may be assigned a key (or a token) capable of decrypting the encrypted table of correspondence 122, during program execution. The authorized user may, therefore, restore the encrypted table of correspondence 122 by using the key, have access to the special commands 112 of the binary source file 110 based on the restored table of correspondence, and restore the modified binary source file 110 to thereby use the software.

Accordingly, when all of the jumps 111 of the binary source file 110 are replaced by the special commands 112, it may be very difficult for hackers to reverse-engineer the software or to have unauthorized access to the binary source file 110 without the table of correspondence 121. Moreover, because the table of correspondence 121, in which a list of the replaced jumps 111 is recorded, is encrypted using the hardware security key 131, it is also very difficult for hackers to decrypt the encrypted table of correspondence 121. Further, because decryption is performed by hardware during actual program execution, a load applied to the CPU is reduced, thus enabling fast restoration.

Methods of protecting a software source file according to one or more exemplary embodiments will now be described based on flowcharts.

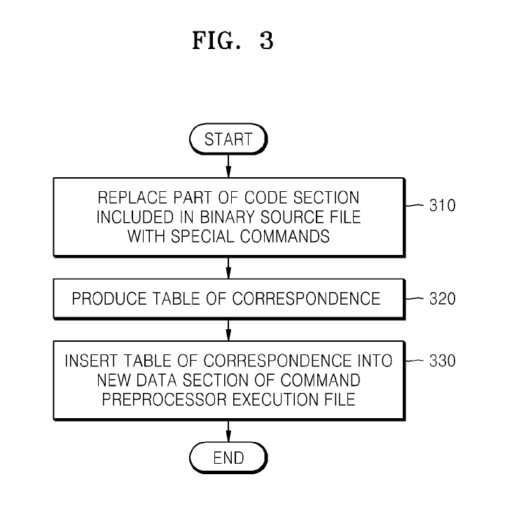

FIG. 3 is a flowchart of the method for increasing the safety of software according to an exemplary embodiment.

Referring to FIG. 3, to increase the safety of software, in operation 310, a binary source file, such as the binary source file 110 of FIG. 1, may be modified by replacing a part of a code section included in the binary source file, so that unauthorized users cannot access the binary source file. For example, jumps are searched for from the code section, and the found jumps are replaced by at least one special command, for example the special command 112 as shown in FIG. 1. Together with the modification of the binary source file, in operation 320, a table of correspondence, such as the table of correspondence 121 shown in FIG. 1, is produced so that the replaced code section part may be restored during software execution. When the table of correspondence is completed, in operation 330, the table of correspondence is inserted into a new data section of a command preprocessor execution file in order to restore the modified binary source file during software execution, thereby modifying the command preprocessor.

Due to this replacement of only a part of the code section of the binary source file, reverse-engineering of software or unauthorized accesses to the binary source file may be prevented.

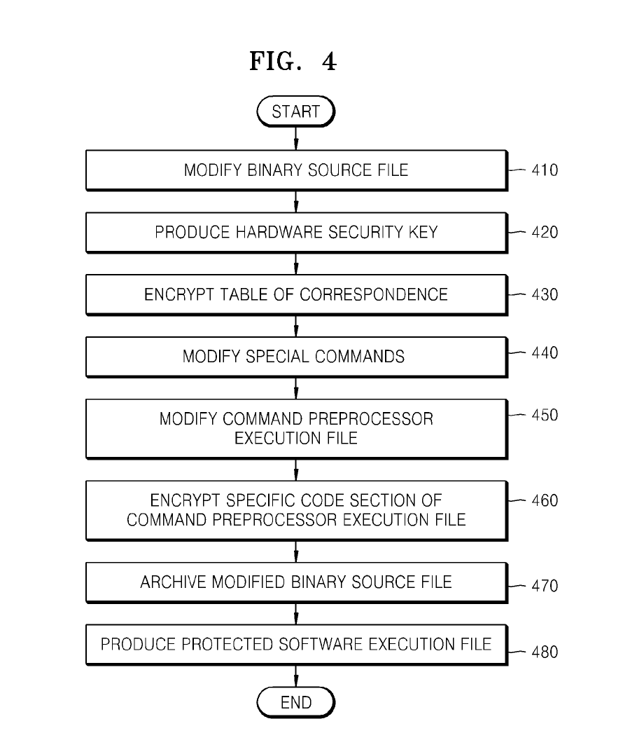

FIG. 4 is a flowchart of an operation of generating a modified binary source file and a modified command preprocessor execution file for software security according to an exemplary embodiment.

Referring to FIG. 4, first, a binary source file, such as the binary source file 110 of FIG. 1, is modified, in operation 410. In this operation, a part of the code section of the binary source file is replaced to create the table of correspondence.

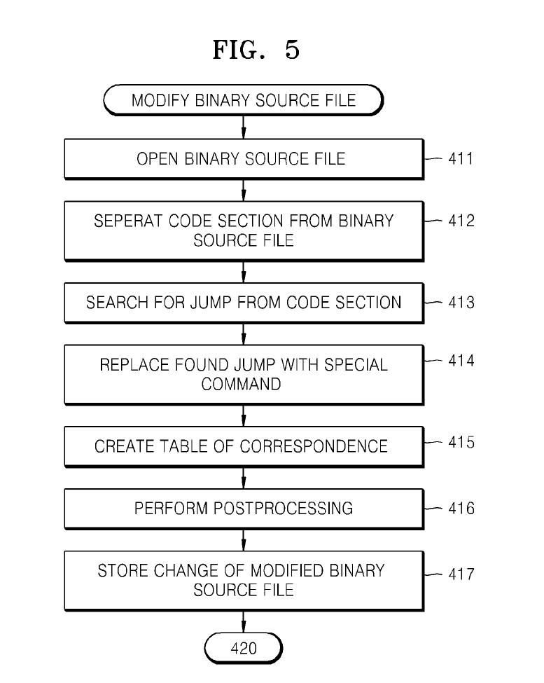

In detail, referring to FIG. 5, first, in operation 411, the binary source file is read from a software file according to an exemplary embodiment. In operation 412, the code section is separated from the binary source file. In operation 413, a jump, for example the jump 111 as shown in FIG. 1, is searched for in the code section. For example, after the code section is separated from the read binary source file, a conditional jump and/or an unconditional jump is searched for in the code section.

If the jump is found in the code section of the binary source file, the jump is replaced by a special command, in operation 414. The special command may be a key value corresponding to the location of the replaced jump or may be a command for replacing the conditional or unconditional jump of the binary source file. Of course, the special command is not limited thereto, and may be a value arbitrarily set by a designer.

This replacement may not stop with the replacement of the single jump. Particularly, replacement of some or all of the jumps found in the code section with the special commands may continue.

When the found jumps are replaced by the special commands, entries into a table of correspondence corresponding to the replacements are created and filled with keys and values, in operation 415. The table of correspondence is required to restore the replaced jumps later.

When the table of correspondence is completed, postprocessing for using modification factors is conducted in operation 416.

The postprocessing helps a consumer to restore a binary source file, and denotes a process for providing the rules about the contents and usage of the binary source file to consumers.

When the postprocessing is completed, the modification of the binary source file is completed by storing the modified binary source file in operation 417.

Referring back to FIG. 4, when the modification of the binary source file 110 is completed, a hardware security key, for example the hardware security key 131 shown in FIG. 2, is produced in operation 420.

According to an exemplary embodiment, the hardware security key is created by the hardware encryption module and performs encryption so that unauthorized users may not restore the replaced jumps. The hardware security key may be a pool of keys or a token, and is created by the hardware encryption module. Methods such as Hardware Against Software Piracy (HASP), Hardlock, and eToken may be used to create the hardware security key. Of course, a method used to produce the hardware security key is not limited thereto, and other methods may be used.

When the production of the hardware security key is completed, the table of correspondence is encrypted in operation 430.

In detail, referring to FIG. 2, according to an exemplary embodiment, the produced hardware security key 131 and the table of correspondence 121 may be combined to produce the encrypted table of correspondence 122. According to another embodiment, a table of correspondence may be modified to be more easily restored or to be restored with more difficulty, by using a special algorithm, before the table of correspondence is encrypted.

Referring back to FIG. 4, when the encryption of the table of correspondence is completed, the special commands are modified, in operation 440.

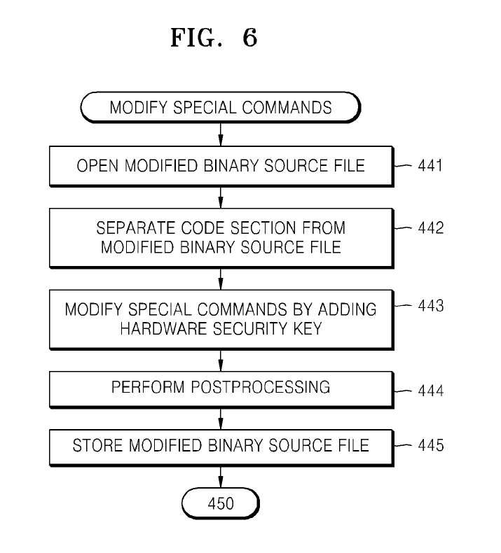

In detail, referring to FIG. 6, a modified binary source file, similar to the modified binary source file 110 shown in FIG. 1, is opened in operation 441. Then, a code section is separated from the modified binary source file in operation 442. In operation 443, special commands, similar to the special commands 112 shown in FIG. 1, existing in the separated code section are searched for, and a hardware security key, similar to the hardware security key 131 shown in FIG. 1, is added. As described above, because the special commands have values or keys that represent the locations of replaced jumps in the binary source file, the special commands may be used to restore the original binary source file. Accordingly, the special commands may be combined with the hardware security key in order to prevent unauthorized users from accessing the special commands. In this case, according to an exemplary embodiment, all of the special commands may be encrypted at once by producing only one hardware security key. According to another embodiment, values corresponding to replacements of the jumps may be individually encrypted by producing separate hardware security keys corresponding to the replacement of each jump. The former provides lower security compared with the latter. Further, in the former, a lower processing load is applied to the CPU because only one hardware security key is used.

When the modification, namely, the encryption, of the special commands is completed, postprocessing is performed in operation 444. When the postprocessing is completed, the binary source file as modified is stored to complete the modification of the binary source file in operation 445.

Referring back to FIG. 4, when the modification of the special commands is completed, the command preprocessor execution file is modified in operation 450.

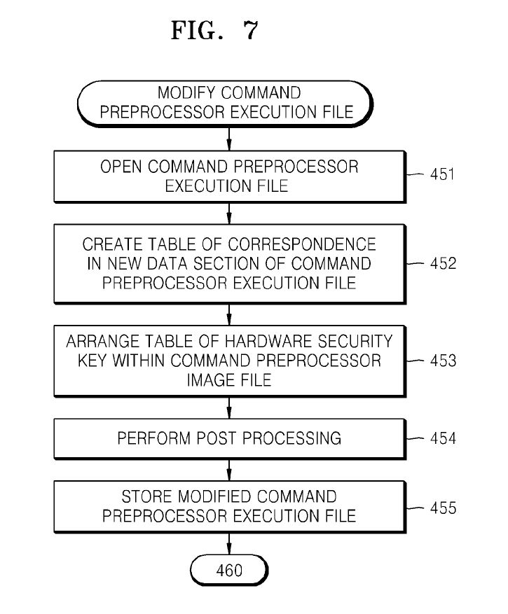

In detail, referring to FIG. 7, the command preprocessor execution file is opened in operation 451. Then, a table of correspondence, similar to the table of correspondence 121 shown in FIG. 1, is created in a new data section of the command preprocessor execution file, in operation 452. The table of correspondence created in the command preprocessor execution file is used to restore a modified binary source file, similar to the modified binary source file 110 shown in FIG. 1. According to an exemplary embodiment, as described above with reference to operation 430 of FIG. 4, the encrypted table of correspondence obtained by combining the table of correspondence with the hardware security key in operation 430 of FIG. 4 may be inserted into the command preprocessor execution file. When the creation of the table of correspondence is completed, a table of the hardware security key is arranged within a command preprocessor file, in operation 453. The table of the hardware security key is used to access the special commands combined with the hardware security key in operation 440 of FIG. 4. When arranging the table of the hardware security key within a command preprocessor file is completed, a result of the modification of the command preprocessor execution file is stored, in operation 454. Thus, authorized users are able to restore the modified binary source file to the original binary source file by using the table of the hardware security key arranged within the command preprocessor file and use the original binary source file.

Referring back to FIG. 4, when the modification of the command preprocessor execution file is completed, a specific code section of the command preprocessor execution file is encrypted in operation 460.

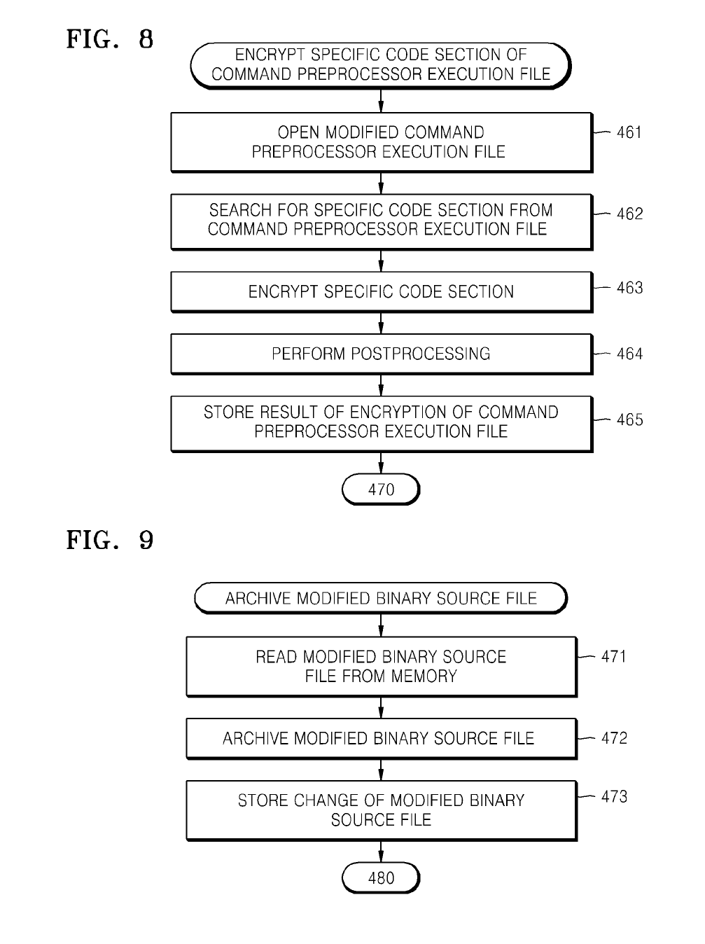

In detail, referring to FIG. 8, in operation 461, the modified command preprocessor execution file is opened. In operation 462, a specific code section is separated and searched for from the modified command preprocessor execution file. In operation 463, the specific code section is encrypted. The encrypted specific code section stores information used to restore a binary source file, similar to the binary source file 110 shown in FIG. 1, and thus corresponds to the whole or a part of the modified command preprocessor execution file in which a table of correspondence, similar to the table of correspondence 121 shown in FIG. 2, is recorded and/or the whole or a part of the modified command preprocessor execution file in which the table of the hardware security key 131 is stored. The encryption may be performed by any method provided by hardware. Thus, an encryption method based on a hardware encryption module, similar to the hardware encryption module 130 shown in FIG. 1, is used again, and thus a low load may be applied to the CPU during decryption. When the encryption of the specific code section is completed, postprocessing is performed, in operation 464. A result of the encryption of the command preprocessor execution is stored, in operation 465.

Referring back to FIG. 4, when the encryption of the specific code section of the modified command preprocessor execution file has been completed, the modified binary source file as modified is archived to produce an execution file of the software, in operation 470.

In detail, referring to FIG. 9, first, a binary source file, similar to the binary source file 110 shown in FIG. 1, as modified is read from memory, in operation 471. In operation 472, the binary source file as modified is archived. In operation 473, a change of the binary source file as modified is stored.

Referring back to FIG. 4, when the archiving of the binary source file as modified is completed, a protected software execution file is produced, in operation 480.

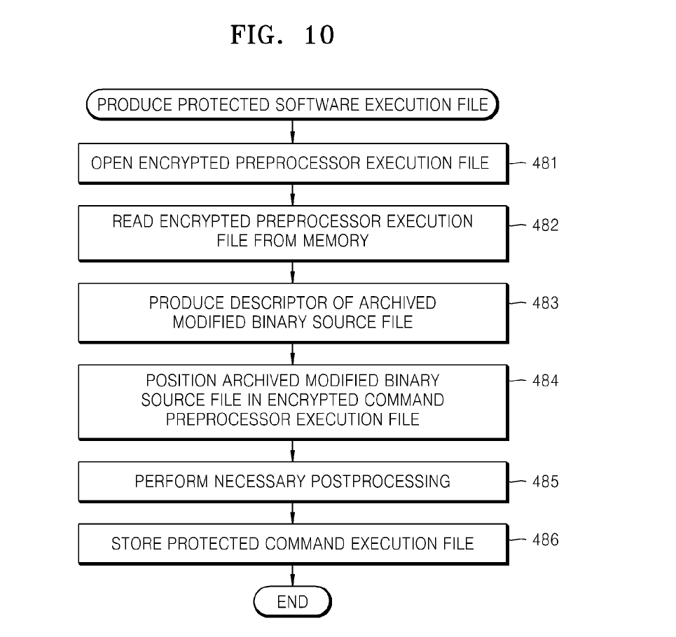

In detail, referring to FIG. 10, first, the encrypted command preprocessor execution file is opened, in operation 481. Then, the encrypted command preprocessor execution file is read from memory, in operation 482. When the reading of the encrypted command preprocessor execution file from memory is completed, a descriptor of the archived modified binary source file is produced in the data section of the encrypted command preprocessor execution file, in operation 483. In operation 484, the archived modified binary source file is positioned in the encrypted command preprocessor execution file. In operation 485, postprocessing is performed. In operation 486, a protected execution command preprocessor execution file is stored. In this way, a protected execution file including the modified binary source file and the encrypted command preprocessor execution file is produced.

The aforementioned operations may not be necessarily performed in the aforementioned order, and some of the aforementioned operations may be omitted according to security levels required by designers or other operations may be further added to reinforce the software security.

The method for increasing the security of software is not limited to specific operating systems (OSs), and the method may support a cross-platform solution that supports not only PCs, but also TVs, tablet PCs, and smart phones.

Even though only conditional and unconditional jumps corresponding to a part of a source file are replaced using a method for increasing the security of software according to an exemplary embodiment, the hacking danger is low due to automatic security key creation or the like by using a hardware encryption module during encryption of the source file. Moreover, due to the use of the hardware encryption module, a high load may be prevented from being applied to a CPU during encryption and/or decryption.

When software modules or algorithms are involved, these software modules may be stored on a computer-readable recording medium as program instructions or computer readable codes executable by the processor. Examples of the computer-readable recording medium include magnetic storage media (e.g., read-only memory (ROM), random-access memory (RAM), floppy disks, hard disks, etc.), and optical recording media (e.g., CD-ROMs, or digital versatile disks (DVDs)). The computer readable recording medium can also be distributed over network coupled computer systems so that the computer readable code is stored and executed in a distributed fashion. This media can be read by the computer, stored in the memory, and executed by the processor.

For the purposes of promoting an understanding of the applicable principles, reference has been made to the exemplary embodiments illustrated in the drawings, and specific language has been used to describe these embodiments. However, no limitation of the scope of the present general inventive concept is intended by this specific language, and the present general inventive concept should be construed to encompass all embodiments that would normally occur to one of ordinary skill in the art.

The present general inventive concept may be described in terms of functional block components and various processing steps. Such functional blocks may be realized by any number of hardware and/or software components configured to perform the specified functions. For example, the present general inventive concept may employ various integrated circuit components, e.g., memory elements, processing elements, logic elements, look-up tables, and the like, which may carry out a variety of functions under the control of one or more microprocessors or other control devices. Similarly, where the elements of the present general inventive concept are implemented using software programming or software elements, the present general inventive concept may be implemented with any programming or scripting language such as C, C++, Java, assembly, or the like, with the various algorithms being implemented with any combination of data structures, objects, processes, routines or other programming elements. Functional aspects may be implemented by using algorithms that are executed by one or more processors. Furthermore, the present general inventive concept could employ any number of conventional techniques for electronics configuration, signal processing, data processing, and the like. The words “mechanism”, “element”, “means”, and “configuration” are used broadly and are not limited to mechanical or physical embodiments, but can include software routines in conjunction with processors, for example.

The particular implementations shown and described herein are illustrative examples of the present general inventive concept and are not intended to otherwise limit the scope of the present general inventive concept in any way. For the sake of brevity, conventional electronics, control systems, software development and other functional aspects of the systems may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the present general inventive concept (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The present invention is not limited to the described order of the steps. The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to one of ordinary skill in the art without departing from the spirit and scope of the present invention.

While the present general inventive concept has been particularly shown and described with reference to exemplary embodiments thereof, it will be understood by those of ordinary skill in the art that various changes in form and details may be made therein without departing from the spirit and scope of the present general inventive concept as defined by the following claims.

What is claimed is:

1. A method for increasing security of software, the method comprising:
replacing a part of a code section included in a binary source file of the software with a pre-set special command;
creating a table of correspondence that contains correspondence information between the part of the code section and the pre-set special command according to the replacing; and
inserting the table of correspondence into a command preprocessor execution file of the software.

2. The method of claim 1, wherein the part of the code section is at least one of a conditional jump and an unconditional jump.

3. The method of claim 2, wherein the table of correspondence comprises at least one of the pre-set special command, the conditional jump, the unconditional jump, a conditional jump location, and an unconditional jump location.

4. The method of claim 1, further comprising encrypting the table of correspondence.

5. The method of claim 4, wherein the encrypting is provided by a hardware device.

6. The method of claim 1, wherein the pre-set special command represents a location of the replaced part of the code section.

7. The method of claim 6, wherein the pre-set special command is comprised in the table of correspondence.

8. The method of claim 1, further comprising:
creating a hardware security key; and
encrypting the pre-set special command using the hardware security key.

9. The method of claim 8, wherein at least one hardware security key is created to encrypt each of a plurality of pre-set special commands.

10. The method of claim 8, wherein all of a plurality of pre-set special commands are encrypted using a single hardware security key.

11. The method of claim 8, wherein the hardware security key is created using at least one of a Hardware Against Software Piracy (HASP) method, a Hardlock method, and an etoken method.

12. The method of claim 1, further comprising:
performing postprocessing that allows a user to use a modified file,
wherein a modified binary source file and a modified command preprocessor execution file are stored in response to the postprocessing being completed.

13. The method of claim 12, further comprising:
encrypting a code section of the modified command preprocessor execution file in which the table of correspondence exists.

14. The method of claim 13, wherein the encrypting is provided by a hardware device.

15. The method of claim 12, further comprising:
archiving the modified binary source file; and
producing a descriptor of the archived modified binary source file in a data section of the modified command preprocessor execution file.

16. A non-transitory computer-readable recording medium having recorded thereon a computer program, which, when executed by a computer, performs the method of claim 1.

17. A method of protecting a binary source file, the method comprising:
replacing at least one of a conditional jump and an unconditional jump in the binary source file with a special command;
recording values that correspond to the replacing in a table of correspondence; and
performing encryption of the binary source file and the table of correspondence using a hardware security key generated by a hardware encryption module.

18. A non-transitory computer-readable medium storing a program executable by a computer to perform a method of protecting a binary source file, the method comprising:
replacing, using a processor, at least one of a conditional jump and an unconditional jump in the binary source file with a special command;
recording values that correspond to the replacing in a table of correspondence; and
performing encryption of the binary source file and the table of correspondence using a hardware security key generated by a hardware encryption module.

19. An electronic apparatus configured to protect a binary source file, the electronic apparatus comprising:
at least one processor that is configured to:
replace at least one of a conditional jump and an unconditional jump in the binary source file with a special command;
record values that correspond to the replacing in a table of correspondence; and
perform encryption of the binary source file and the table of correspondence using a hardware security key generated by a hardware encryption module.
